(19) United States
(12) Patent Application Publication
(10) Pub. No.: US 2008/0002551 A1
(43) Pub. Date: Jan. 3, 2008

(54) OPTICAL DISK RECORDER AND OPTICAL DISK RECORDING METHOD

(76) Inventors: Shunsuke KIMURA, Yokohama-shi (JP); Akihito Ogawa, Yokohama-shi (JP); Hideki Takahashi, Kashiwa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/769,120

(22) Filed: Jun. 27, 2007

(30) Foreign Application Priority Data
Jun. 30, 2006 (JP) 2006-182335

(51) Int. Cl. G11B 7/00

(52) U.S. Cl. 369/100

(57) ABSTRACT

According to one embodiment, an optical disk recorder has a control unit that records user data to a second recording area of a first layer before recording user data to a fourth recording area of a second layer and records pattern data in at least one of a first recording area and a third recording area, with respect to a multilayer recording medium comprising the first layer which has the first recording area provided on an inner circumferential side of an optical disk, the second recording area provided on an outer circumferential side thereof, to which user data is recorded, and the third recording area provided on an outer circumferential side thereof, and the second layer which has the fourth recording area laminated on the first layer, to which user data is recorded.

### CROSS-REFERENCE TO RELATED APPLICATIONS

This application is based upon and claims the benefit of priority from Japanese Patent Application No. 2006-182335, filed Jun. 30, 2006, the entire contents of which are incorporated herein by reference.

### BACKGROUND

1. Field

One embodiment of the present invention relates to an optical disk recorder and an optical disk recording method which handle recordable optical disks.

2. Description of the Related Art

Recently, digital data recording media have been gaining popularity. For example, in the information recording media represented by DVD (digital versatile disc), etc., information is densified and recording layers are provided in multilayers. Now, for example, on both ends of the recording area in which user data of each recording layer is recorded, a guard zone is provided and pattern data, etc. are written therein.

In patent document 1 (Jpn. Pat. Appln. KOKAI Publication No. 2005-63589), there is disclosed a technique to initiate recording user data in a recording layer of the shifted recording layer after pattern data, etc. are recorded in the guard zone in the shifted recording layer with care to prevent trouble in reproduction operation even before finalization is conducted, in the event that the record is shifted from one recording layer to the next recording layer in the user data recording operation.

In the conventional technique of patent document 1, for example, when the record is shifted from the first recording layer to the second recording layer, timing of recording to the guard zone of the second recording layer is defined. However, the problem to be solved by the invention is to deal with the timing, etc. for recording pattern data, etc. in the guard zone in the first recording layer which is irradiated with laser beam. Consequently, in the conventional technique of patent document 1, the optimum timing and method for recording the pattern data, etc. in the guard zone (in the present application, Guard Track Zone: hereinafter called “GTZ”) in the first recording layer are not identified.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of connections of an optical disk device which handles multilayer type optical disks according to one embodiment of the present invention;

FIG. 2 is a block diagram showing one example of connections between a host PC and an optical disk device which handles multilayer type optical disks according to one embodiment of the present invention;

FIG. 3 is a block diagram showing one example of a detailed configuration of an optical disk device which handles multilayer type optical disks according to one embodiment of the present invention;

FIG. 4 is an illustration showing one example of a general configuration of a multilayer optical disk according to one embodiment of the present invention;

FIG. 5 is an illustration showing one example of a layout of each layer of a multilayer type optical disk (double-layer HD DVD-R) according to one embodiment of the present invention;

FIG. 6 is a diagram for explaining an interlayer crosstalk of a multilayer type optical disk (double-layer HD DVD-R) according to one embodiment of the present invention;

FIG. 7 is a transition diagram for explaining one example of data recording sequence when the middle area of the optical disk device according to one embodiment of the present invention is not expanded;

FIG. 8 is a transition diagram for explaining one example of data recording sequence when the small-size middle area of the optical disk device according to one embodiment of the present invention is expanded;

FIG. 9 is a transition diagram for explaining one example of data recording sequence when the large-size middle area of the optical disk device according to one embodiment of the present invention is expanded;

FIG. 10 is a flow chart that shows one example of GTZ recording operation in response to media insertion on the host PC side of the optical disk device according to one embodiment of the present invention;

FIG. 11 is a flow chart that shows one example of GTZ recording operation of the optical disk device according to one embodiment of the present invention;

FIG. 12 is a flow chart that shows another example of GTZ recording operation which involves a question screen on the host PC side of the optical disk device according to one embodiment of the present invention;

FIG. 13 is a flow chart that shows one example of GTZ recording operation in response to a recording command of the optical disk device according to one embodiment of the present invention;

FIG. 14 is a flow chart that shows another example of GTZ recording operation in response to a recording command of the optical disk device according to one embodiment of the present invention; and

FIG. 15 is a flow chart that shows one example of GTZ recording operation in response to a middle area expansion command of the optical disk device according to one embodiment of the present invention.

### DETAILED DESCRIPTION

Various embodiments according to the invention will be described hereinafter with reference to the accompanying drawings. In general, according to one embodiment of the invention, an optical disk recorder, comprising: a control unit which irradiates with laser beam to record user data in a second recording area of a first layer and pattern data in at least one of a first recording area and a third recording area, before user data is recorded in a fourth recording area of a second layer, with respect to a multilayer information recording medium comprising a first layer having the first recording area provided on an inner circumferential side of a disk-form optical disk, the second recording area provided on an outer circumferential side thereof in which user data is recorded, and the third recording area provided on an outer circumferential side thereof and the second layer having the fourth recording area laminated on the first layer and in which user data is recorded.

One embodiment of the present invention provides an optical disk recorder and an optical disk recording method which define a recording method to a guard track zone GTZ provided in a first recording layer irradiated with laser beam.

One embodiment to solve the problem is,

an optical disk recorder that has a control unit (250) that irradiates a laser beam to record user data in a second recording area (DA30) of a first layer before recording user data in a fourth recording area (39) of a second layer and record pattern data in at least one of a first recording area (22) and a third recording area (31), with respect to a multilayer information recording medium (10) comprising the first layer (L0) which has the first recording area (GTZ22) provided on an inner circumferential side of an optical disk, the second recording area (DA30) provided on an outer circumferential side thereof, to which user data is recorded, and the third recording area (GZ31) provided on an outer circumferential side thereof, and the second layer (L1) which has the fourth recording area (39) laminated on the first layer, to which user data is recorded.

In this manner, the write characteristics into the second layer are stabilized by recording the pattern data, etc. in the guard track zone GTZ located right below a disk test zone of the second layer (L1) to which the data is transferred. Thus, a recording strategy with accurate test write results of the disk test zone reflected can be obtained. Further, because the data can be recorded in the second layer (L1) with this recording strategy, the record performance of the second layer to which the data is transferred is improved.

Referring now to the drawings, an optical disk recorder and an optical disk recording method according to one embodiment of the present invention will be described in detail.

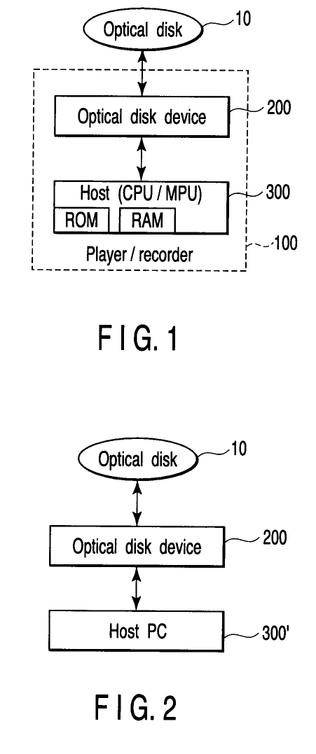

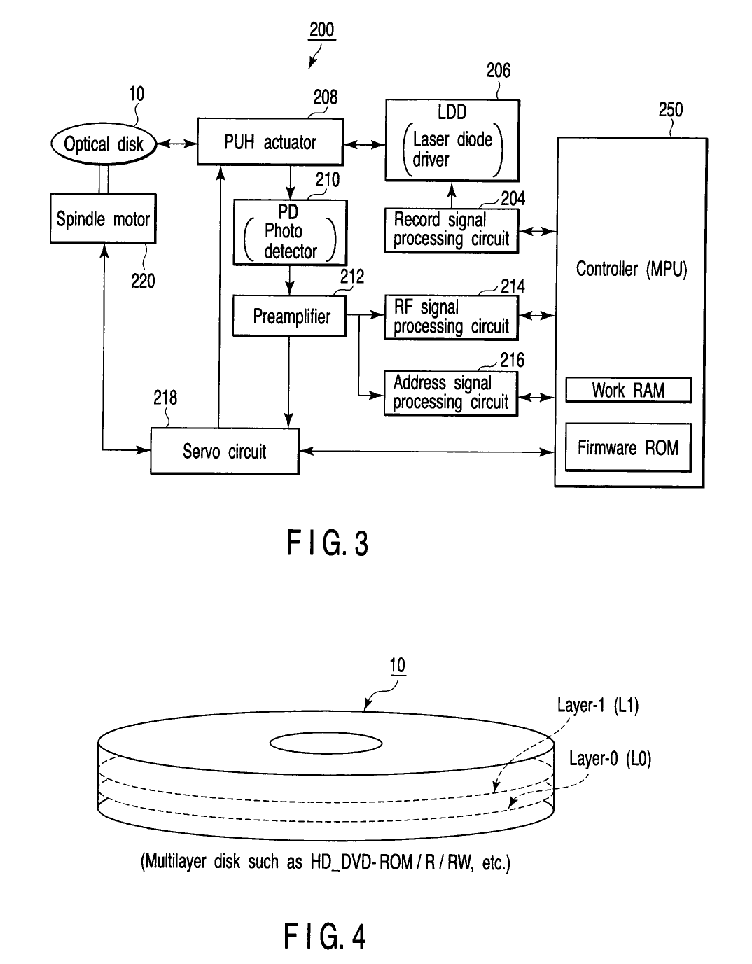

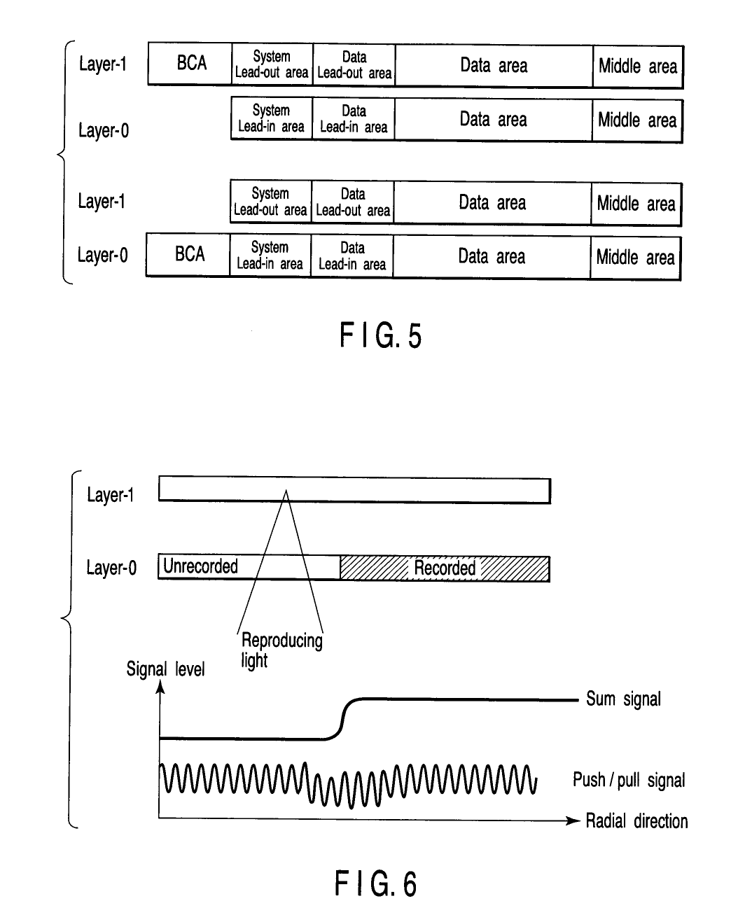

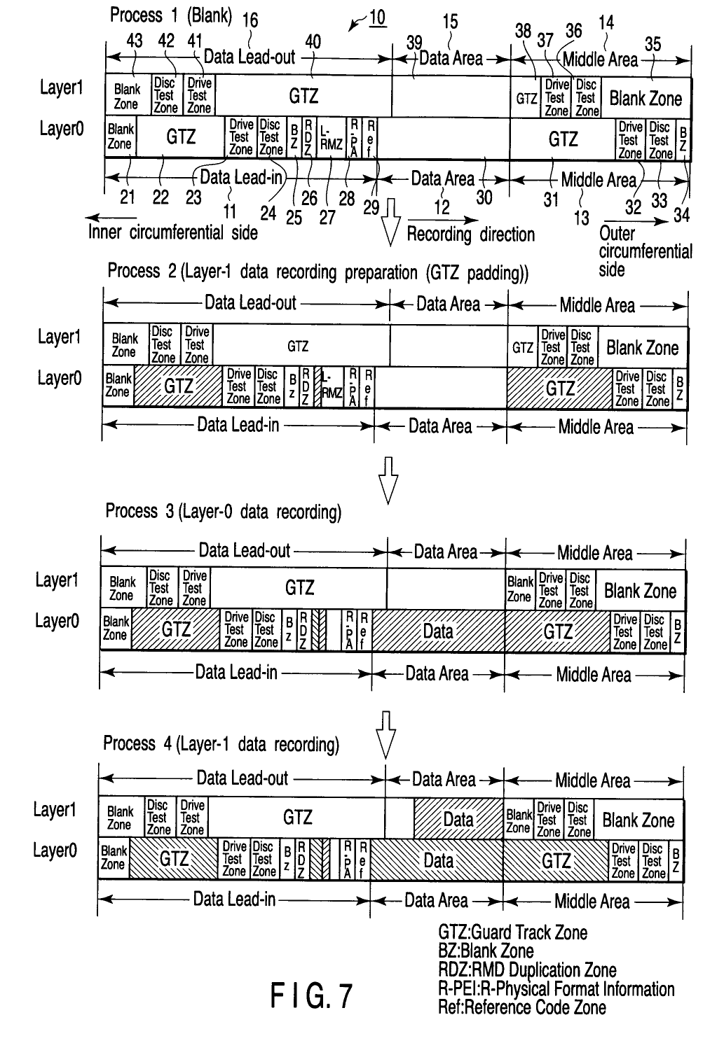

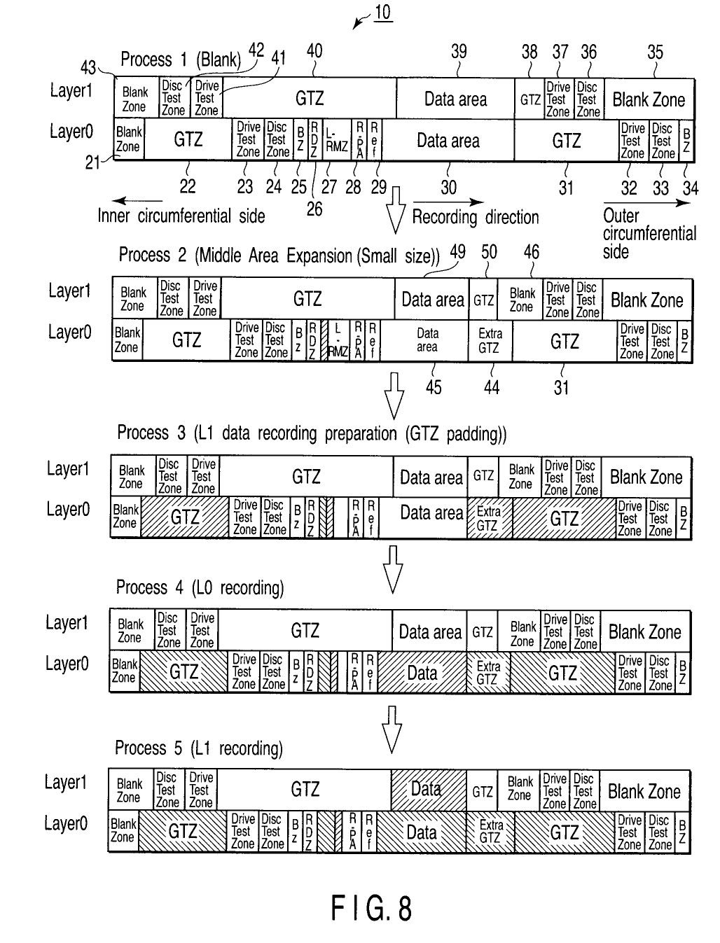

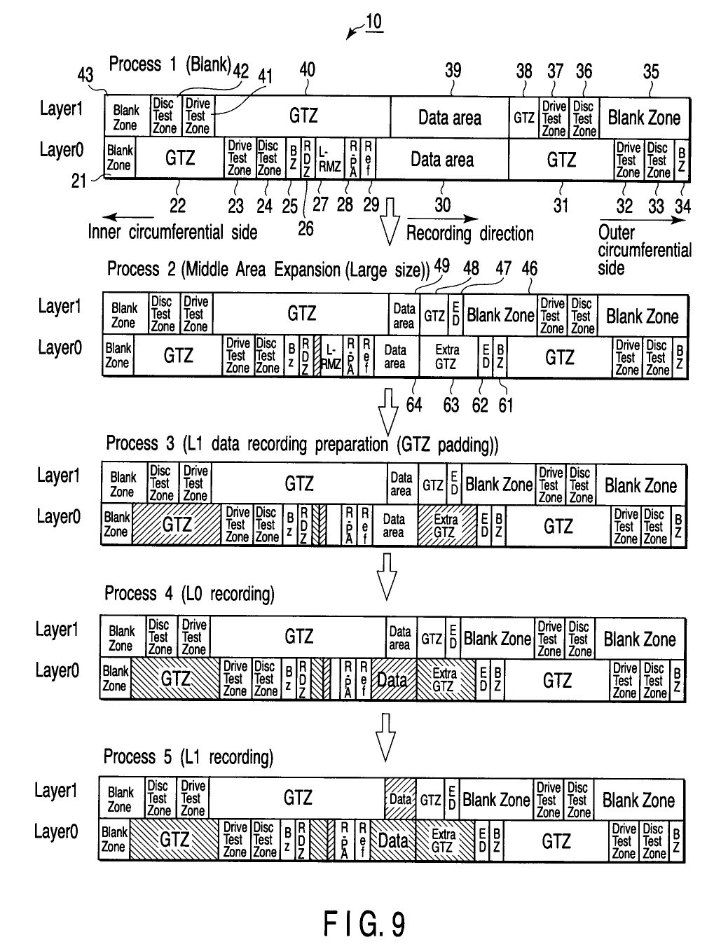

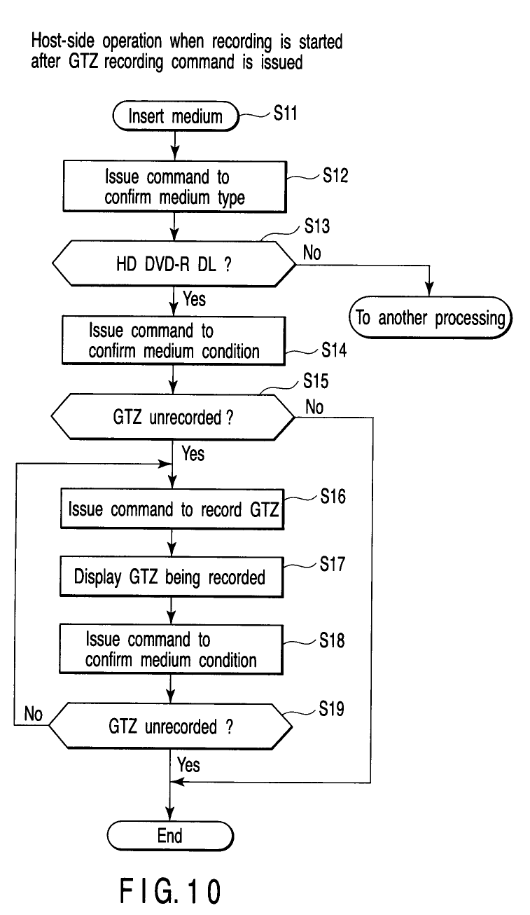

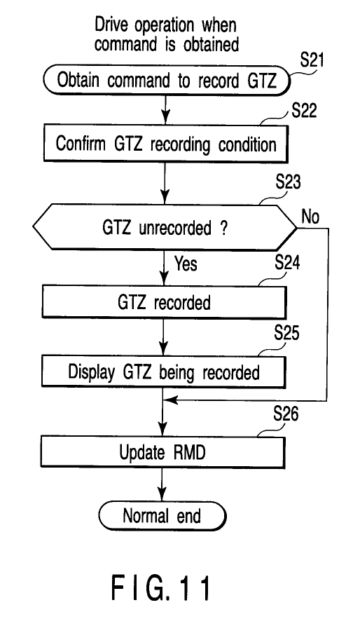

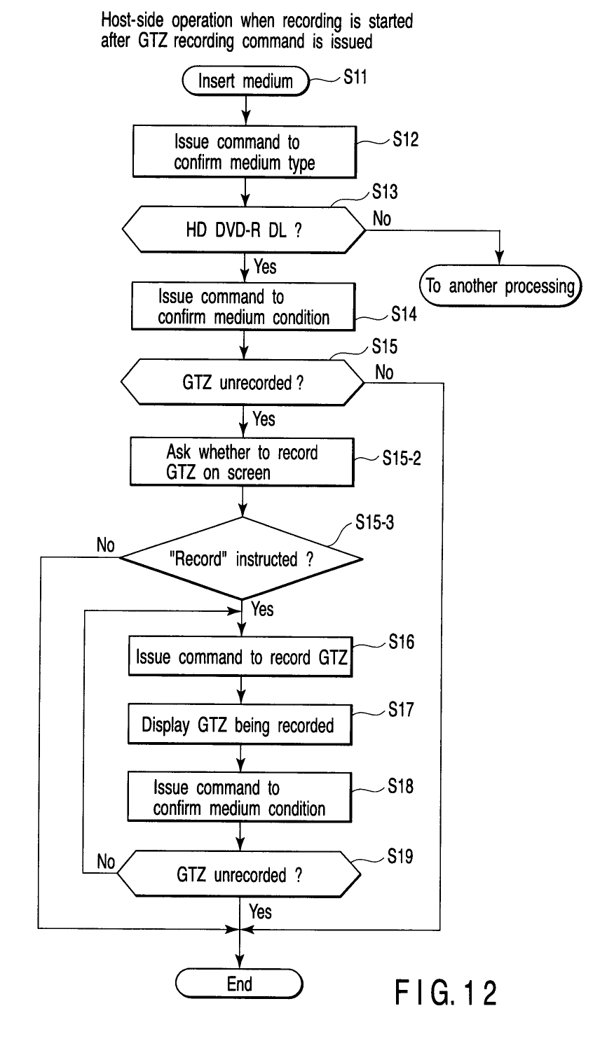

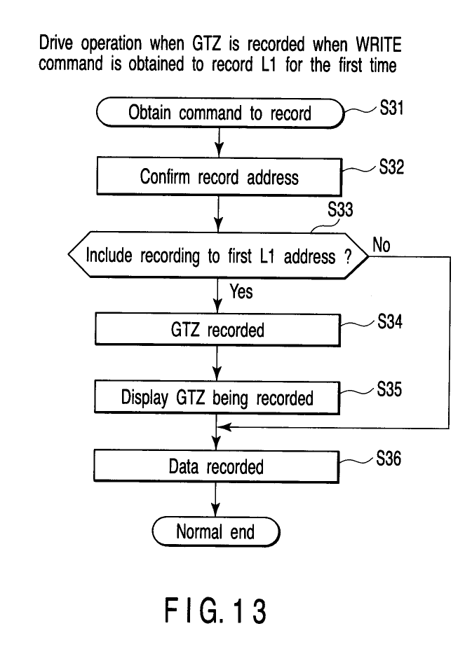

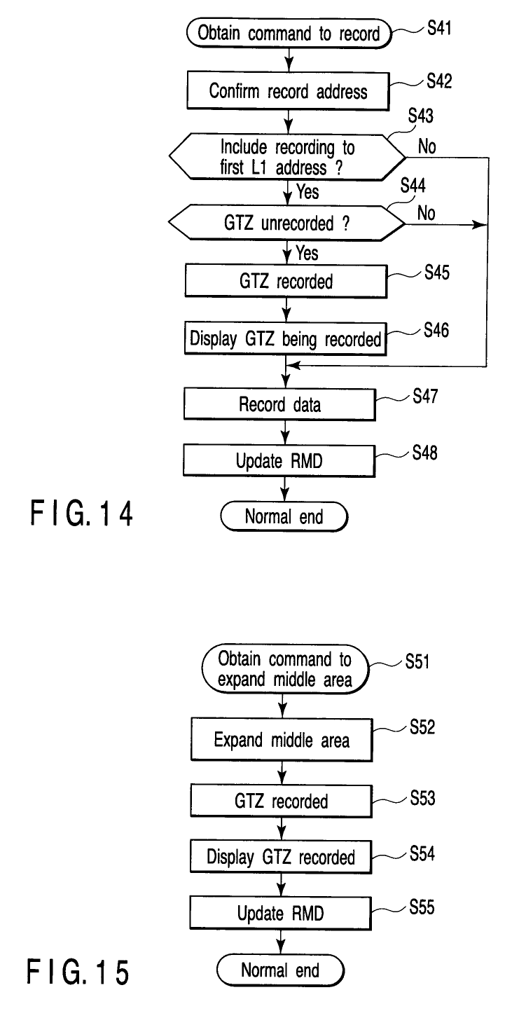

FIG. 1 is a block diagram showing connections of an optical disk device which handles multilayer type optical disks according to one embodiment of the present invention. FIG. 2 is a block diagram showing one example of connections between a host PC and an optical disk device which handles multilayer type optical disks according to one embodiment of the present invention. FIG. 3 is a block diagram showing one example of a detailed configuration of an optical disk device which handles multilayer type optical disks according to one embodiment of the present invention. FIG. 4 is an illustration showing one example of a general configuration of a multilayer optical disk according to one embodiment of the present invention. FIG. 5 is an illustration showing one example of a layout of each layer of a multilayer type optical disk (double-layer HD DVD-R) according to one embodiment of the present invention. FIG. 6 is a diagram for explaining an interlayer crosstalk of multilayer type optical disks (double-layer HD DVD-R) according to one embodiment of the present invention. FIG. 7 is a transition diagram for explaining one example of data recording sequence when the middle area of the optical disk device according to one embodiment of the present invention is not expanded. FIG. 8 is a transition diagram for explaining one example of data recording sequence when the small-size middle area of the optical disk device according to one embodiment of the present invention is expanded. FIG. 9 is a transition diagram for explaining one example of data recording sequence when the large-size middle area of the optical disk device according to one embodiment of the present invention is expanded. FIG. 10 is a flow chart that shows one example of GTZ recording operation in response to media insertion on the host PC side of the optical disk device according to one embodiment of the present invention. FIG. 11 is a flow chart that shows one example of GTZ recording operation of the optical disk device according to one embodiment of the present invention. FIG. 12 is a flow chart that shows another example of GTZ recording operation which involves a question screen on the host PC side of the optical disk device according to one embodiment of the present invention. FIG. 13 is a flow chart that shows one example of GTZ recording operation in response to a recording command of the optical disk device according to one embodiment of the present invention. FIG. 14 is a flow chart that shows another example of GTZ recording operation in response to a recording command of the optical disk device according to one embodiment of the present invention. FIG. 15 is a flow chart that shows one example of GTZ recording operation in response to a middle area expansion command of the optical disk device according to one embodiment of the present invention.

<Optical Disk Recording/Reproducing System>

First of all, one example of an optical disk recording/reproducing system according to one embodiment of the present invention will be described with reference to the drawings. FIG. 1 is a block diagram for explaining a general configuration of an information recording/reproducing system (player/recorder) 100 which records and/or reproduces information with respect to disk-form multilayer information recording media (for example, double-layer HD DVD-R) according to one embodiment of the present invention.

The information recording/reproducing system 100 shown in FIG. 1 is configured by including: an optical disk 10 that stores voice/picture information (AV information), user data, etc.; an optical disk device (or disk drive device) 200 that records information in the optical disk 10 and/or reproduces information from the optical disk 10; and a host section 300 that issues commands to the optical disk device 200, reads necessary information from the optical disk 10 via the optical disk device 200, reproduces AV information, displays information to users, etc.

The apparatus 100 such as optical disk recorders and optical disk players incorporate the optical disk device 200 and the host section 300 in the apparatus as shown in FIG. 1. The host section 300 is equipped with a CPU (central processing unit) or MPU (micro processing unit), RAM (random access memory) used as a working area, ROM (read only memory) or nonvolatile memory that stores and retains setting parameters and various data, etc. which must be maintained even when the power supply is turned off.

As this nonvolatile memory, an EEPROM (electrically erasable and programmable ROM), a flash memory, etc. can be used. In these ROMs or nonvolatile memory, various programs (firmware) to be executed according to user requirements, data necessary for processing, file systems necessary for file management, etc. can be recorded. For example, in these ROMs or nonvolatile memory, a UDF bridge file system in a DVD-video format, a UDF file system in a DVD video recording format, a UDF file system in an advanced video format (HD DVD-Video), a UDF file system in an advanced video recording format (HD DVD-Recordable), application software, etc. are stored.

The write operation into GTZ later discussed is achieved by the operation program stored in this RAM or ROM, as one example.

FIG. 2 describes a general configuration of a personal computer that records and/or reproduces information to/from disk-form multilayer information recording media according to one embodiment of the present invention. In FIG. 1, the host section 300 is specially prepared for the apparatus 100, but in FIG. 2, a CPU/MPU of the personal computer is used as the host section 300 by software (virtual software player/recorder attached to the operating system).

In the system such as a personal computer as shown in FIG. 2, a host PC 300′ serves as a host. Issuance of instructions to the optical disk device 200 (for example, versatile DVD multidrive incorporated in a note PC) connected to the host PC 300′ is implemented by executing application software such as OS (operation software), writing software, and video reproduction software.

<Optical Disk Device>

FIG. 3 is a block diagram for explaining the general configuration of the optical disk device (disk drive device) 200 shown in FIG. 1 or 2. The optical disk device 200 records and reproduces information by focusing (aligning the focal point to the applicable recording layer by a focus servo) a laser beam radiated from an optical pick-up head (PUH) 208 to an information recording layer inside the optical disk 10 which is rotatably driven by a spindle motor 220. The light reflected from the disk 10 (its layer 0 and/or layer 1) passes through the optical system of the PUH 208 again and is detected as an electrical signal at a photo detector (PD) 210.

The detected electrical signal is amplified by a preamplifier 212 and outputted to a servo circuit 218 and signal processing circuits 214 and 216. In the servo circuit 218, servo signals such as focus, tracking, tilt, and rotating speed are generated, and the servo signals are respectively outputted to focus, tracking, and tilt actuators not illustrated in the PUH 208. In addition, the servo signal of rotating speed is sent to the drive circuit system of the spindle motor 220, and the linear velocity of the laser beam spot on the recording layer of the disk is controlled to a specified value.

In the signal processing circuits 214 and 216, recorded data is read and address signals, etc. are demodulated. As the demodulation method in such event, there are a slice system and a PRML (partial response maximum likelihood) system. In the slice system, there are a method for binarizing signals after performing linear waveform equalization to reproduction signals, and a method for binarizing signals after equalizing the signals by a nonlinear equalizer called limit equalizer that limits high-amplitude components of a low band of reproduction signals to a predetermined value. In addition, with respect to the PRML system, the optimum PR class such as PR (1, 2, 2, 2, 1), PR (1, 2, 1), PR (1, 2, 2, 1), or PR (3, 4, 4, 3), etc. is chosen in accordance with frequency characteristics of reproduction signals.

The optical disk device 200 selects the optimum demodulation system (slice system or PRML system) in accordance with the optical disk 10 subject to recording/reproduction and the size of the focusing beam spot formed by the PUH 208.

In the address signal processing circuit 216, by processing the detected signals, “physical address information” that shows the recording position on the optical disk is read and outputted to a controller 250. The controller 250 reads the data (user data, etc.) at a desired address location or records the data in the desired address location on the basis of this address information. In such event, the record data is modulated into record waveform control signals suited for optical disk recording by a record waveform circuit which is not illustrated in a record signal processing circuit 204 or in a laser diode driver LDD (laser diode drive circuit) 206. Based on this modulated signals, the laser diode driver LDD 206 emits light of a laser diode and records information in the optical disk 10 (information recording layer of layer-0 and/or layer-1 illustrated in FIGS. 4 and 5).

In this embodiment, in the optical head PUH 208, one single waveform light source or a plurality of single waveform light sources of any of wavelength 405±15 nm, 650±20 nm, or 780±30 nm are loaded. In addition, the objective lens used for focusing the coherent laser beam of the above wavelength onto the recording layer in the optical disk 10 by the optical head PUH 208 has a numerical aperture (NA) of 0.65 in this embodiment.

However, as other embodiments, it is possible to have a construction to switch the objective lens so that the objective lens with an NA value of 0.65 is used when recording/reproduction is carried out on an information recording medium in an H-format and the objective lens of 0.85=NA is used when recording/reproduction is carried out on an information recording medium in a B-format.

By the way, the relative intensity in the vicinity of the objective lens (opening boundary location) when the center intensity is “1” is called “RIM Intensity” as the intensity distribution of incident light immediately before the light impinges on the objective lens. The value of the RIM intensity in the H format is set to be 55 to 70%. The wavefront aberration in the optical head in such event is optically designed to become at least 0.33% (0.33λ or less) with respect to the usable light wavelength λ.

<Configuration and Characteristics of Optical Disk>

Referring now to the drawings, one example of a configuration of the multilayer information recording medium (double-layer HD DVD-R), which is an optical disk handled by the optical disk device according to the present invention, will be described in detail as follows.

FIG. 4 is a drawing that explains the general configuration of the multilayer information recording medium (double-layer HD DVD-R) in a disk form according to one embodiment of this invention. As shown in FIG. 4, the multilayer information recording medium has two information recording layers (layer-0 and layer-1) and has characteristics of being configured with continuous or discontinuous logic spaces. In addition, as shown in FIG. 5, the layer-1 has BCA, system lead-out area, data lead-out area, data area, and middle area, whereas the layer-0 has system lead-out area, data lead-out area, data area, and middle area.

One example of a still more detailed configuration is shown in FIG. 7. That is, the multilayer information recording medium (double-layer HD DVD-R) 10 used in one embodiment of the present invention has data lead-in 11, data area 12, middle area 13, middle area 14, data area 15, data lead-out 16, blank zone 21, GTZ 22, drive test zone 23, disk test zone 24, blank zone 25, RMD duplication zone 26, L-RMZ 27, R-PA 28, reference code zone 29, data area 30, guard track zone 31, drive test zone 32, disk test zone 33, blank zone 34, blank zone 35, disk test zone 36, drive test zone 37, guard track zone 38, data area 39, guard test zone 40, drive test zone 41, disk test zone 42, and blank zone 43 as shown in 1. Blank in FIG. 7.

Furthermore, the multilayer information recording medium (double HD DVD-R) 10 used in one embodiment of the present invention has a case with the data areas 45 and 49 reduced in accordance with the setting signals (commands, etc.) shown in FIG. 8, and includes an extra guard track zone 44, a reduced data area 45, a blank zone 46, a reduced data area 49 and guard track zone 50.

Furthermore, the multilayer information recording medium (double HD DVD-R) 10 used in one embodiment of the present invention has a case with the data areas 45 and 49 greatly reduced in accordance with the setting signals shown in FIG. 9, and includes a blank zone 46, an extra drive test zone 47, a guard track area 48, an extra drive test zone blank zone 61, an extra drive test zone 62, an extra guard track area 63, and a data area 64.

Problem of Interlayer Crosstalk

Next discussion will be made on the interlayer crosstalk of the optical disk of the present invention. In the double disk of the present invention, when the recording condition of the recording layer of the layer-0 at the position under reproduction is changed while the layer-1 is being reproduced as shown in FIG. 6, a problem of offsetting the signals of the layer-1 under reproduction due to the crosstalk occurs.

That is, when signals are recorded in the layer-1, the optimum recording power varies depending on whether the layer-1 is recorded or unrecorded. This is because the transmissivity and the reflectivity of the recording medium of the layer-0 vary between the recorded state and the unrecorded state or because the width of the intermediate layer cannot be increased to suppress optical aberration, and it is extremely difficult to physically reduce these characteristics.

Therefore as shown in FIGS. 8 and 9, a method for providing a clearance (recording prohibited area) by user setting and limiting the usable data area in advance is employed.

In such event, the record enable area of the layer-1 is the range with the clearance on both sides subtracted from the recorded range of the layer-0. This clearance width can be obtained from Eq. (1).

Clearance=Δr+e+Δs Eq. (1)

where, Δr denotes a relative deviation of actual radius positions of the same design radii of the layer-0 and layer-1, which is caused by manufacturing errors, etc., and e the eccentricity rate. In addition, Δs denotes a radius of a beam spot formed in a layer which is not in reproduction.

Conditions for Recording Data into Data Area of Layer-1

When the layer-1 is recorded, in order to keep the recording quality, it is necessary to have the layer-0 recorded in the corresponding radius position to consider the influence of the above-mentioned interlayer crosstalk. In the event that the recording sequence to the data area begins with the inner circumference of layer-0 and advances to the outer circumferential side, and after recording of the layer-0 finishes to the outermost circumference of the data area, recording advances from the outer circumference of the layer-1 to the inner circumferential side thereof, when the beginning of the data area of the layer-1 (outermost circumference of the data area of layer-1) is recorded, it is necessary for the vicinity of the outer circumference of the data area of the layer-0 to have been recorded and at the same time for part (guard track zone: GTZ) on the inner circumferential side of the middle area of the layer-0 to have been recorded.

In addition, in order to enable trial recording to record the layer-1, it is necessary to record the guard track zone of the data lead-in area. However, the trial recording is carried out at a drive test zone of each area (data lead-in area, data lead-out area, and middle area). The trial recording to record the layer-1 is conducted in the drive test zone in the layer-1 of the data lead-out area and the middle area.

Setting these conditions before data recording is started can reduce the time required to transfer records between recording layers.

<GTZ Record Processing in Optical Disk Device>

Referring now to the transition diagrams of FIGS. 7 to 9 and the flow charts of FIGS. 10 to 15, data record processing in an optical disk device primarily focused on the GTZ will be discussed in detail as follows with these optical disk characteristics taken into account. By the way, each step of all the following flow charts can be replaced with a circuit block, and consequently, the steps of each flow chart can be re-defined by blocks.

GTZ Recording by Inserting Media

First of all, referring to the flow charts of FIGS. 7 and 10, description will be made on a case in which GTZ record processing is triggered by detection of loading of media such as HD DVD-R on an unillustrated disk table, etc. by an unillustrated sensor.

FIG. 10 is a flow chart of the host operation when GTZ is recorded by a command from the host, and FIG. 11 shows an operation flow chart of an optical disk device. In the host section 300 or 300′, first of all, an unillustrated sensor detects that the optical disk 10 is inserted and loaded into a disk table, etc. (Step S11), and the host issues a command to check the type of the disk (Step S12). Then, in the host section 300 or 300′, whether or not the inserted disk is a double-layer HD DVD-R is judged (Step S13).

In this event, another processing is performed if the medium is not a double-layer HD DVD-R. If the medium is a double-layer HD DVD-R, processing in the host section 300 or 300′ proceeds to Step S14 and a command is issued to obtain disk information such as GTZ recorded condition (Step S14). Then, whether or not GTZ has already been recorded is judged (Step S15), and if GTZ has been recorded, processing is suspended. If GTZ has not yet been recorded, the host section 300 or 300′ issues a command to direct GTZ recording (Step S16).

In this manner, the controller 250 of the optical disk device 200 controls to record data which is not the user data such as regular content data, etc. but pattern data, noise data, etc. in GTZ 22 on the inner circumferential side and GTZ31 on the outer circumferential side of process 1 of FIG. 7.

By the way, with respect to which of GTZ22 on the inner circumferential side or GTZ31 on the outer circumferential side should be recorded first, either one can be recorded first and this does not cause any great technical working effect.

When the controller 250 of the optical disk device 200 obtains the command to direct GTZ recording issued from the host 300 or 300′ (Step S16) (Step S21), the controller 250 confirms the GTZ recorded condition (Step S22). As a result of the confirmation, if GTZ22 on the inner circumferential side and GTZ31 on the outer circumferential side are not recorded, the controller 250 conducts recording of these GTZs (Step 24) and notifies the host section 300 or 300′ of GTZ under recording (Step S25). Upon completion of such recording, RMD is updated in order to note that record processing to the GTZ has been completed (Step S26). That is, each piece of GTZ recording information, layout information of the middle area, etc. are recorded in the disk as recording management data (RMD).

In the event of recording to the GTZ, it is desirable for the host section 300 to output signals to display a screen that indicates the GTZ currently under recording (Step S17). This is to prevent a user from misunderstanding that the recording time to the GTZ is a failure because it frequently takes long time, for example, around 1 minute, to record the data into the GTZ.

Furthermore, the host section 300 or 300′ issues a command to the optical disk device 200 to confirm the media condition (GTZ recorded condition) (Step S18), and controls these record processing until it confirms that GTZ has been recorded (Step S19).

Thereafter, as shown in process 3 of FIG. 7, the content data, etc. which is the user data is recorded in the data area 30 of the layer-0, and furthermore, as shown in process 4 of FIG. 7, the content data, etc. which is the user data is recorded in the data area 39 of the layer-1.

In this way, automatically record-processing the GTZ with the media insertion used as a trigger definitely brings the GTZ in the recorded condition and record-processing of the layer-1 can be performed under stable characteristics.

GTZ Record-Processing in User Directions

With reference to the flow chart in FIG. 12, next discussion will be made on the case in which GTZ recording is performed by user directions. FIG. 12 shows the operation flow chart of an optical disk device in the event that GTZ is also recorded when the data is recorded in the first address of the layer-1.

As shown in Step S15-2 of the flow chart of FIG. 12, it is desirable that the host section 300 or 300′ outputs image display signals to ask questions such as “Conduct GTZ pattern data write-processing?”, etc. on an operation screen not illustrated when a medium is inserted, by a confirmation screen not illustrated (Step S15-2). This is because GTZ write time is bothersome when record-processing is desired to be performed immediately since it takes time to write the GTZ. In such event, it is desirable to carry out GTZ recording, for example, when records are transferred from the layer-0 to the layer-1.

That is, it is preferable to carry out GTZ record-processing on and after Step S16 when there is an operation signal from the user to record for this confirmation screen (selection of YES icon) (Step S15-3).

GTZ Recording Conducted by Transferring Record to Layer-1

Referring now to the flow chart of FIG. 13, GTZ recording will be described in detail, which is achieved by transferring the user data record to the layer-1. FIG. 14 shows an operation flow chart of an optical disk device in the event that GTZ is recorded when the data is recorded in the first address of the command or the layer-1.

When the controller 250 of the optical disk device 200 obtains a recording command (Step S31), the controller 250 confirms this record address (Step S32), and judges whether or not this address is a record instruction command to record the first address of the layer-1 (Step S33). Otherwise, the controller 250 carries out record-processing of regular content data, etc. (Step S36).

However, in the event that this address includes recording to the first address of the layer-1, GTZ record-processing is performed (Step S34). By the way, in such event, it is desirable for the controller 250 of the optical disk device 200 to output display signals to display a display screen indicating that GTZ is currently being recorded (Step S35). Thereafter, the controller 250 performs record-processing of regular content data, etc. (Step S36).

In this way, pattern data, etc. are recorded in the guard track zones GTZ31 and 22 located right below the disk test zones 36 and 42 of the second layer (layer-1) to which the data is transferred, by carrying out GTZ record-processing when record-processing moves from the layer-O to the layer-1. Because this stabilizes the write characteristics of the second layer (layer-1), record storage with the test write results of the disk test zone accurately reflected can be obtained. In addition, since the second layer (layer-1) can be recorded with this record storage, the record performance of the second layer to which the data is transferred can be definitely improved.

Furthermore, in the flow chart of FIG. 14, processing from Step S31 to S36 of the flow chart of FIG. 13 are nearly the same as the processing from Step S31 to S37 of the flow chart of FIG. 14. Here, in step S44, whether or not the GTZ is unrecorded is judged and record-processing of GTZ is more definitely performed. In addition, in Step S48, this record-processing of GTZ is recorded by updating RMD, which is management information.

GTZ Recording by Middle Area Expansion

Referring now to transition diagrams of FIGS. 8 and 9 and the flow chart of FIG. 15, GTZ-recording by middle area expansion will be described further in detail. FIGS. 8 and 9 show the record sequence when the data is recorded after the middle area is expanded.

Note that the middle area is expanded for the following. For example, in the event that the content data of about 10 minutes are recorded in a disk, a large unrecorded area is kept remained, and an extremely long time is required to carry out finalize-processing to create bits in the unrecorded area. To solve this kind of trouble, the middle area is expanded to narrow the covered area subject to the finalize-processing. This processing is performed to shorten the finalize-processing time.

In the event that the controller 250 of the optical disk device 200 obtains the middle area expansion command (Step S51), the controller 250 expands the middle area as shown in transition diagrams of FIGS. 8 and 9.

That is, in FIG. 8, the physical sector number of layer-O of the middle area after expansion is 726C00h or more.

The condition of process 1 of FIG. 8 indicates the unused disk. Process 2 of FIG. 8 indicates the condition with the middle area expanded by the expansion directions, etc. of the host PC300′, and ExGTZ 44 is added and the data area 45 is reduced. Furthermore, in the layer-1, the blank zone 46, the extra drive test zone 47, and the GTZ 48 are generated, and the data area 49 is reduced.

Under this condition, by the directions, etc. of the host PC 300′, part of the middle area, in this case, GTZ31 and EXGTZ 44 of the layer-0 are recorded. In addition, GTZ22 of the data lead-in area is recorded. Thereafter, data recording is started in the data areas 45 and 49.

FIG. 9 shows a transition diagram when a middle area still larger than that in FIG. 8 is expanded. The physical sector number of the layer-0 of the middle area after expansion is smaller than 726C00h.

The condition of process 1 of FIG. 9 indicates the unused disk. Process 2 of FIG. 9 indicates the condition with the middle area expanded by the expansion directions, etc. of the host PC300′, and ExGTZ 63 larger than the ExGTZ 44 of FIG. 8 is added and the data area 64 is further reduced. Furthermore, in the layer-1, the blank zone 46, the extra drive test zone 47, and the GTZ 48 are generated, and the data area 49 is reduced.

Under this condition, by the directions, etc. of the host PC 300′, part of the middle area, in this case, extra GT263 of the layer-0 is recorded. However, in this event, it is characterized by that no record-processing is carried out to GTZ31. In addition, GTZ22 of the data lead-in area is recorded. Thereafter, data recording is started in the data areas 64 and 49.

Referring again to the flow chart of FIG. 15, before data-recording to these data areas is performed, record information of each GTZ, layout information of the middle area, etc. are temporarily recorded in a disk as the recording management data (RMD) (Step S55).

The optical disk device reads the information and in the event that any inquiry is received from the host PC 300′, the optical disk device transmits these pieces of information to the PC 300′.

In this way, the write characteristics of the second layer is stabilized by recording pattern data, etc. in a guard track zone GTZ located right below the disk test zone of the second layer-1 to which the data is transferred, by carrying out GTZ recording when a middle area expansion command is received. Consequently, because record storage with the test write results of the disk test zone accurately reflected can be obtained and the layer-1 can be recorded by this record storage, the record performance of the second layer to which the data is transferred can be improved.

By the foregoing various embodiments, a person skilled in art can achieve the present invention. Furthermore, it is easy for a person skilled in art to conceive of many variations of these embodiments and it is possible to apply them to various embodiments without having inventive capabilities. Consequently, the present invention will cover a wide range that does not conflict with the disclosed principle and novel characteristics, and shall not be limited by any of the above-mentioned embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk recorder, comprising:
a control unit which irradiates with laser beam to record user data in a second recording area of a first layer and pattern data in at least one of a first recording area and a third recording area, before user data is recorded in a fourth recording area of a second layer,
with respect to a multilayer information recording medium comprising a first layer having the first recording area provided on an inner circumferential side of a disk-form optical disk, the second recording area provided on an outer circumferential side thereof in which user data is recorded, and the third recording area provided on an outer circumferential side thereof and the second layer having the fourth recording area laminated on the first layer and in which user data is recorded.

2. The optical disk recorder according to claim 1, wherein the control unit records pattern data in a position where a disk test zone provided in the second layer in the first recording area of the first layer exists and in a position where a disk test zone provided in the second layer in the third recording area exists.

3. The optical disk recorder according to claim 1, wherein the control unit records user data in the second recording area after recording pattern data in the first recording area and the third recording area in the first layer.

4. The optical disk recorder according to claim 1, wherein the control unit records pattern data in the first recording area and the third recording area after recording user data in the second recording area in the first layer.

5. The optical disk recorder according to claim 1, wherein the control unit reduces the second recording area to provide a fifth recording area and records pattern data in the fifth recording area in accordance with given setting signals.

6. The optical disk recorder according to claim 1, wherein the control unit reduces the second recording area to provide a fifth recording area and records pattern data not in the third recording area but in the fifth recording area in accordance with given setting signals.

7. The optical disk recorder according to claim 1, wherein the control unit records pattern data in the first recording area and the third recording area when it detects that the multilayer information recording medium is loaded to a disk table.

8. The optical disk recorder according to claim 1, wherein the control unit outputs a screen display signal indicating that pattern data is currently being recorded while the pattern data is being recorded in the first and third recording areas.

9. The optical disk recorder according to claim 1, wherein the control unit outputs a screen display signal to ask whether pattern data is to be recorded in the first recording area and the third recording area when it detects that the multilayer information recording medium is loaded to a rotating unit that rotates the multilayer information recording medium.

10. Optical disk recording method comprising:
irradiating with laser beam to record user data in a second recording area of a first layer and recording pattern data in at least one of a first recording area and a third recording area before recording user data in a fourth recording area of a second layer,
with respect to a multilayer information recording medium comprising a first layer having the first recording area provided on an inner circumferential side of a disk-form optical disk, the second recording area provided on an outer circumferential side thereof in which user data is recorded, and the third recording area provided on an outer circumferential side thereof and the second layer having the fourth recording area laminated on the first layer and in which user data is recorded.

11. The optical disk recording method according to claim 10, wherein pattern data is recorded in a position where a disk test zone provided in the second layer in the first recording area of the first layer exists and in a position where a disk test zone provided in the second layer in the third recording area exists.

12. The optical disk recording method according to claim 10, wherein user data is recorded in the second recording area after recording pattern data in the first recording area and the third recording area in the first layer.

13. The optical disk recording method according to claim 10, wherein pattern data is recorded in the first recording area and the third recording area after recording user data in the second recording area in the first layer.

14. The optical disk recording method according to claim 10, further comprising reducing the second recording area to provide a fifth recording area and recording pattern data in the fifth recording area in accordance with given setting signals.

15. The optical disk recording method according to claim 10, wherein the second recording area is reduced to provide a fifth recording area and pattern data is recorded not in the third recording area but in the fifth recording area in accordance with given setting signals.

16. The optical disk recording method according to claim 10, wherein pattern data is recorded in the first recording area and the third recording area when it is detected that the multilayer information recording medium is loaded to a disk table.

17. The optical disk recording method according to claim 10, wherein a screen display signal is output to indicate that pattern data is currently being recorded while the pattern data is being recorded in the first and third recording areas.

18. The optical disk recording method according to claim 10, wherein a screen display signal is output to ask whether pattern data is to be recorded in the first recording area and the third recording area when it is detected that the multilayer information recording medium is loaded to a rotating unit that rotates the multilayer information recording medium.
